(19) United States
(12) Patent Application Publication
(10) Pub. No.: US 2026/0148492 A1
(43) Pub. Date: May 28, 2026

(54) Method and Apparatus for Three-Dimensional Reconstruction

(71) Applicant: Shining 3D Tech Co., Ltd., Hangzhou (CN)

(72) Inventors: Chao MA, Hangzhou (CN); Han CHEN, Hangzhou (CN); Xiaojun CHEN, Hangzhou (CN); Xiaobo ZHAO, Hangzhou (CN)

(73) Assignee: Shining 3D Tech Co., Ltd., Hangzhou (CN)

(21) Appl. No.: 19/413,177

(22) Filed: Dec. 9, 2025

Related U.S. Application Data
(63) Continuation of application No. PCT/CN2024/095819, filed on May 28, 2024.

(30) Foreign Application Priority Data
Jun. 9, 2023 (CN) 202310687963.2

(51) Int. Cl. G06T 17/00; G06T 7/00; G06T 7/80; G06V 10/145; G06V 10/74; G06V 10/77

(52) U.S. Cl. CPC G06T 17/00; G06T 7/0012; G06T 7/80; G06V 10/145; G06V 10/761; G06V 10/7715; G06T 2207/30036

(57) ABSTRACT

Provided are a method and an apparatus for three-dimensional reconstruction. The method includes: acquiring a first image and a second image, wherein the first image and the second image are obtained by respectively collecting a target image by a pre-calibrated binocular camera; respectively determining positions of feature points in the first image and the second image, and respectively determining a plurality of first adjacent domains corresponding to the feature points in the first image and a plurality of second adjacent domains corresponding to the feature points in the second image; matching the feature points in the first image with the feature points in the second image one to one according to matching degree between the first adjacent domains and the 10 second adjacent domains; and performing three-dimensional reconstruction of an object to be measured according to matched feature points in the first image and the second image.

### CROSS-REFERENCE TO RELATED APPLICATIONS

This application is a continuation application of PCT/CN2024/095819 filed on May 28, 2024, which claims priority to Chinese Patent Application No. 202310687963.2, filed on Jun. 9, 2023 and entitled “Method and Apparatus for Three-Dimensional Reconstruction”, the entire contents of each of which are incorporated herein by reference for all purposes.

### TECHNICAL FIELD

Embodiments of the present application relates to the field of three-dimensional reconstruction, and in particular, to a method and an apparatus for three-dimensional reconstruction.

### BACKGROUND

In the related art, in the field of dental treatment, the method for acquiring dental model data has gradually shifted from impression-based three-dimensional scanning to intraoral three-dimensional scanning technology. The technology discards the method for acquiring dental model data from impression taking, cast pouring, and three-dimensional scanning, enabling direct intraoral scanning to acquire three-dimensional tooth data. The oral digital impression device, also known as an intraoral three-dimensional scanner, is a device for directly scanning the oral cavity of a patient by using an intraoral optical scanning probe to acquire three-dimensional morphology and color texture information of surfaces of soft and hard tissues such as teeth, gums and mucous membranes in the oral cavity. One method employed by the device is to use an active structured light triangulation principle to project an active light pattern using a digital projection system, and after acquiring the pattern, a camera acquisition system performs three-dimensional reconstruction and aligning by means of algorithm processing. That is, the integrity of the data in the area is reduced. Due to the confined space inside the oral cavity, the size of the intraoral optical scanning probe is inevitably limited, so each scan can only acquire images of up to two teeth at a time, resulting in low scanning efficiency.

### SUMMARY

According to one aspect of the embodiments of the present application, provided is a method for three-dimensional reconstruction. The method includes: acquiring a first image and a second image, wherein the first image and the second image are obtained by respectively collecting a target image by a pre-calibrated binocular camera, the target image is formed by a projected pattern projected onto a surface of an object to be measured, and the projected pattern is at least composed of binarized stripes containing feature points; respectively determining positions of feature points in the first image and the second image, and respectively determining a plurality of first adjacent domains corresponding to the feature points in the first image and a plurality of second adjacent domains corresponding to the feature points in the second image, wherein the feature points in the first image are in one-to-one correspondence with the first adjacent domains, and the feature points in the second image are in one-to-one correspondence with the second adjacent domains; matching the feature points in the first image with the feature points in the second image one to one according to matching degree between the first adjacent domains and the second adjacent domains; and performing three-dimensional reconstruction of the object to be measured according to matched feature points in the first image and the second image.

In some embodiments of the present application, the projected pattern is determined by the following manners, including: determining types of the binarized stripes, wherein the types of the binarized stripes at least include one of the following: line segment stripes with endpoints as feature points and binarized stripes with feature points randomly distributed on stripes; and arranging the binarized stripes according to predetermined distribution rules to form the projected pattern, wherein the line segment stripes are random in length, and the feature points at least include one of the following shapes: a horizontal line of a preset length, a spherical shape, a cross shape and a square shape.

In some embodiments of the present application, arranging the binarized stripes according to the predetermined distribution rules to form the projected pattern includes: determining a first distribution rule for the binarized stripes from a plurality of horizontal distribution rules included in the predetermined distribution rules, wherein the plurality of horizontal distribution rules includes at least one of the following: horizontal spacings between laterally adjacent binarized stripes being equal, the horizontal spacings between the laterally adjacent binarized stripes being successively increased at equal intervals, and the horizontal spacings between the laterally adjacent binarized stripes being randomly selected from a preset distance interval; determining a second distribution rule for the binarized stripes from the predetermined distribution rules according to the types of the binarized stripes; and arranging the binarized stripes according to the first distribution rule and the second distribution rule to form the projected pattern.

In some embodiments of the present application, determining the second distribution rule for the binarized stripes from the predetermined distribution rules according to the types of the binarized stripes includes: in cases where the binarized stripes in the projected pattern are line segment stripes, selecting a second distribution rule from a plurality of vertical distribution rules included in the predetermined distribution rules, wherein the plurality of vertical distribution rules includes at least one of the following: vertical spacings between longitudinally adjacent line segment stripes being equal, the vertical spacings between the longitudinally adjacent line segment stripes being successively increased at equal intervals, and the vertical spacings between the longitudinally adjacent line segment stripes being randomly selected from a preset distance interval; and in cases where the binarized stripes in the projected pattern are binarized stripes in which feature points are randomly distributed on stripe, selecting a second distribution rule from a plurality of feature point distribution rules included in the predetermined distribution rules, wherein the plurality of feature point distribution rules at least includes: spacings between a plurality of feature points being equal, and the plurality of feature points being randomly distributed on stripes.

In some embodiments of the present application, determining the plurality of first adjacent domains corresponding to the feature points in the first image includes: determining, from the first image, feature points to be matched; determining a sub-image window of a preset size from the first image by using the feature points to be matched as a center; and determining regions delimited by the sub-image window as the first adjacent domains.

In some embodiments of the present application, feature points matching the feature points to be matched are determined from the second image in the following manners, including: determining first adjacent domains corresponding to the feature points to be matched in the first image; sequentially determining a second adjacent domain corresponding to each feature point in the second image; and determining matching degrees between the feature points to be matched and each feature point in the second image according to grayscale values of the feature points to be matched, a grayscale value of each feature point in the second image, an average grayscale value of the first adjacent domains corresponding to the feature points to be matched, and an average grayscale value of the second adjacent domain corresponding to each feature point in the second image; and selecting, from the second image, a feature point having the highest matching degree and meeting an epipolar constraint condition, and taking same as feature points matching the feature points to be matched in the second image.

In some embodiments of the present application, intrinsic and extrinsic parameters of the binocular camera are determined by the following manner, including: extracting feature point coordinates from an image in a calibration board collected by the binocular camera; and calculating the intrinsic and extrinsic parameters of the binocular camera according to the feature point coordinates of the image in the calibration board.

In some embodiments of the present application, calculating the intrinsic and extrinsic parameters of the binocular camera according to the feature point coordinates of the image in the calibration board includes: determining, among a plurality of intrinsic and extrinsic parameters of the binocular camera, target parameters needing to be calibrated, wherein the target parameters include a rotation angle and a translation displacement for transforming a plurality of feature points of the image in the calibration board from a world coordinate system to a camera coordinate system, a camera focal length and a radial distortion coefficient; substituting three-dimensional coordinates of the plurality of feature points of the image in the calibration board and corresponding image coordinates into a preset system of linear equations to determine an optimal solution of the preset system of linear equations; and determining the target parameters on the basis of the optimal solution.

In some embodiments of the present application, determining the target parameters on the basis of the optimal solution includes: determining, on the basis of the optimal solution, an x-axis component and a y-axis component in a rotation matrix corresponding to the rotation angle and an x-axis component and a y-axis component in a translation matrix corresponding to the translation displacement; and sequentially determining the camera focal length and the radial distortion coefficient on the basis of the x-axis component and the y-axis component in the rotation matrix and the x-axis component and the y-axis component in the translation matrix.

According to another aspect of the present application, also provided is a method for three-dimensional reconstruction, including: acquiring a first image and a second image, wherein the first image and the second image are obtained by respectively collecting a target image by a pre-calibrated monocular camera, the target image is formed by a projected pattern projected onto a surface of an object to be measured, and the projected pattern is at least composed of randomly distributed binarized stripes containing feature points; respectively determining positions of feature points in the first image and the second image, and respectively determining a plurality of first adjacent domains corresponding to the feature points in the first image and a plurality of second adjacent domains corresponding to the feature points in the second image, wherein the feature points in the first image are in one-to-one correspondence with the first adjacent domains, and the feature points in the second image are in one-to-one correspondence with the second adjacent domains; matching the feature points in the first image with the feature points in the second image one to one according to matching degree between the first adjacent domains and the second adjacent domains; and performing three-dimensional reconstruction of the object to be measured according to matched feature points in the first image and the second image.

In some embodiments of the present application, acquiring the first image and the second image includes: acquiring the target image at different moments respectively by means of the monocular camera, to obtain the first image and the second image; or acquiring the target image by means of the monocular camera to obtain the first image, and modulating the first image to obtain the second image.

According to still another aspect of the present application, also provided is a method for three-dimensional reconstruction of intraoral teeth, including: acquiring a first image and a second image, wherein the first image and the second image are obtained by respectively collecting a target image by a pre-calibrated binocular camera, the target image is formed by a projected pattern projected onto a surface of a tooth to be measured, and the projected pattern is at least composed of randomly distributed binarized stripes containing feature points; respectively determining positions of feature points in the first image and the second image, and respectively determining a plurality of first adjacent domains corresponding to the feature points in the first image and a plurality of second adjacent domains corresponding to the feature points in the second image, wherein the feature points in the first image are in one-to-one correspondence with the first adjacent domains, and the feature points in the second image are in one-to-one correspondence with the second adjacent domains; matching the feature points in the first image with the feature points in the second image one to one according to matching degree between the first adjacent domains and the second adjacent domains; and performing three-dimensional reconstruction of the tooth to be measured according to matched feature points in the first image and the second image.

According to still another aspect of the present application, also provided is an apparatus for three-dimensional reconstruction, including: an acquisition component, configured to acquire a first image and a second image, wherein the first image and the second image are obtained by respectively collecting a target image by a pre-calibrated binocular camera, the target image is formed by a projected pattern projected onto a surface of an object to be measured, and the projected pattern is at least composed of binarized stripes containing feature points; a determination component, configured to respectively determine positions of feature points in the first image and the second image, and respectively determine a plurality of first adjacent domains corresponding to the feature points in the first image and a plurality of second adjacent domains corresponding to the feature points in the second image, wherein the feature points in the first image are in one-to-one correspondence with the first adjacent domains, and the feature points in the second image are in one-to-one correspondence with the second adjacent domains; a matching component, configured to match the feature points in the first image with the feature points in the second image one to one according to matching degree between the first adjacent domains and the second adjacent domains; and a reconstruction component, configured to perform three-dimensional reconstruction of the object to be measured according to matched feature points in the first image and the second image.

According to yet another aspect of the present application, provided is a computer non-transitory readable storage medium, including a program stored on the computer non-transitory readable storage medium; when the program runs, a device where the computer non-transitory readable storage medium is located is controlled to execute the foregoing method for three-dimensional reconstruction.

According to yet another aspect of the present application, provided is an oral scanner, including: one or more processors, a memory, and one or more programs, wherein the one or more programs are stored in the memory and configured to be executed by the one or more processors, and the one or more programs include instructions configured to perform the method for three-dimensional reconstruction.

### BRIEF DESCRIPTION OF THE DRAWINGS

The drawings of the description, constituting a part of the present application, are used for providing further understanding of the present application, and the illustrative embodiments of the present application and illustrations thereof are used to explain the present application, rather than constitute inappropriate limitation on the present application. In the drawings:

FIG. 1 shows a hardware structural block diagram of a mobile terminal for executing a method for three-dimensional reconstruction according to some embodiments of the present application;

FIG. 2 shows a schematic flowchart of a method for three-dimensional reconstruction according to some embodiments of the present application;

FIG. 3 shows a schematic diagram of a projected pattern according to some embodiments of the present application;

FIG. 4 shows another schematic diagram of a projected pattern according to some embodiments of the present application;

FIG. 5 shows still another schematic diagram of a projected pattern according to some embodiments of the present application;

FIG. 6 shows a schematic diagram of a calibration board pattern according to some embodiments of the present application;

FIG. 7 shows a schematic flowchart of another method for three-dimensional reconstruction according to some embodiments of the present application;

FIG. 8 shows a flowchart of a method for three-dimensional reconstruction of intraoral teeth according to some embodiments of the present application; and

FIG. 9 shows a schematic diagram of an apparatus for three-dimensional reconstruction according to some embodiments of the present application.

### DETAILED DESCRIPTION OF EMBODIMENTS

It should be noted that the embodiments in the disclosure and features in the embodiments can be combined without conflicts. The disclosure will be described below in detail with reference to the drawings and in combination with the embodiments.

In order to make the solutions of the application better understood by those skilled in the art, the technical solutions in the embodiments of the application will be clearly and completely described below in combination with the drawings in the embodiments of the application. It is apparent that the described embodiments are not all embodiments but part of embodiments of the application. All other embodiments obtained by those of ordinary skill in the art on the basis of the embodiments in the present application without creative work shall fall within the scope of protection of the present application.

It is to be noted that terms “first”, “second” and the like in the description, claims and the above-mentioned drawings of the present application are used for distinguishing similar objects rather than describing a specific sequence or a precedence order. It should be understood that the data so used may be interchanged where appropriate, so that the embodiments of the present application described herein can be achieved. In addition, the terms “comprising”, “having” or other variants aim to cover non-exclusive inclusion, such that the processes, methods, systems, articles or devices comprising a series of steps or units not only comprise those steps or units, but also comprise other factors not listed explicitly, or further comprise steps or units intrinsic for such processes, methods, articles or devices.

As described in the background, the related art suffer from the technical problem of low efficiency in dental image scanning, in order to solve the described problem, embodiments of the present application provide a method for three-dimensional reconstruction.

The technical solutions in the embodiments of the present application will be clearly and completely described below with reference to the accompanying drawings in the embodiments of the present application.

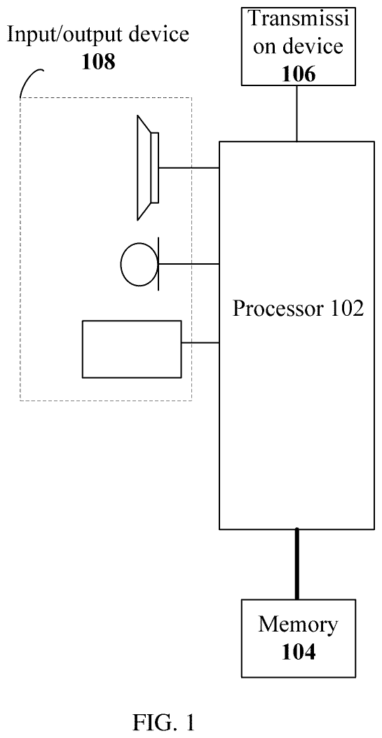

The method embodiment provided in the embodiment I of the present application may be executed in a mobile terminal, a computer terminal, or a similar computing device. By taking running on a mobile terminal as an example. FIG. 1 is a hardware structural block diagram of a mobile terminal in a method for three-dimensional reconstruction according to an embodiment of the present application. As shown in FIG. 1, the mobile terminal may include one or more (only one is shown in FIG. 1) processors 102 (the processors 102 may include, but are not limited to, a microprocessor MCU or a processing device such as a programmable logic device FPGA) and a memory 104 configured to store data, wherein the mobile terminal can further include a transmission device 106 for a communication function and an input/output device 108. Those ordinarily skilled in the art can appreciate that the structure shown in FIG. 1 is for illustrative purposes only, but not limit the structure of the mobile terminal. For example, the mobile terminal may also include more or fewer components than that shown in FIG. 1, or have a different configuration than that shown in FIG. 1.

The memory 104 may be configured to store a computer program, for example, a software program and a module of application software, such as a computer program corresponding to the method for three-dimensional reconstruction in the embodiments of the present application. The processor 102 runs the computer program stored in the memory 104, so as to execute various function applications and data processing, that is, to implement the foregoing method. The memory 104 may include a high-speed random access memory, and may also include a non-transitory memory, such as one or more magnetic storage apparatuses, flash memories, or other non-transitory solid-state memories. In some instances, the memory 104 may further include memories remotely arranged with respect to the processor 102, and these remote memories may be connected to the mobile terminal over a network. Examples of the described network include, but are not limited to the Internet, an intranet, a local area network, a mobile communication network, and a combination thereof. The transmission device 106 is configured to receive or transmit data by a network. Specific examples of the described network may include a wireless network provided by a communication provider of the mobile terminal. In one example, the transmission device 106 includes a network interface controller (NIC for short) which may be connected to other network devices by means of a base station, thereby being able to communicate with the Internet. In one example, the transmission device 106 may be a radio frequency (RF) module for communicating wirelessly with the Internet.

In some embodiments of the present application, a method for three-dimensional reconstruction that runs on a mobile terminal, a computer terminal, or a similar computing apparatus is provided. It should be noted that the steps shown in the flowchart of the drawings can be executed in a computer system such as a set of computer executable instructions. Although the logic order is shown in the flowchart, in some cases, the shown or described steps can be executed in an order different from that described here.

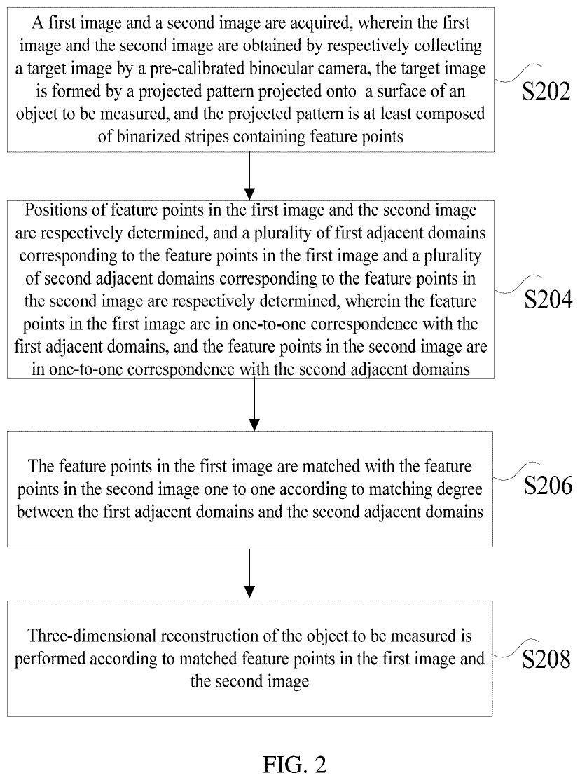

FIG. 2 is a flowchart of a method for three-dimensional reconstruction according to some embodiments of the present application. As shown in FIG. 2, the method includes the following steps:
step S202: a first image and a second image are acquired, wherein the first image and the second image are obtained by respectively collecting a target image by a pre-calibrated binocular camera, the target image is formed by a projected pattern projected onto a surface of an object to be measured, and the projected pattern is at least composed of binarized stripes containing feature points;
step S204: positions of feature points in the first image and the second image are respectively determined, and a plurality of first adjacent domains corresponding to the feature points in the first image and a plurality of second adjacent domains corresponding to the feature points in the second image are respectively determined, wherein the feature points in the first image are in one-to-one correspondence with the first adjacent domains, and the feature points in the second image are in one-to-one correspondence with the second adjacent domains;
step S206: the feature points in the first image are matched with the feature points in the second image one to one according to matching degree between the first adjacent domains and the second adjacent domains; and
step S208: three-dimensional reconstruction of the object to be measured is performed according to matched feature points in the first image and the second image.

In some embodiments of the present application, in the process of oral scanning, the factors determining a single-scan duration are often related to the structured light encoding and decoding time. When designing structured light encoding patterns, the entire image is typically decoded, using methods such as temporal phase unwrapping and spatial phase unwrapping. While having acquired the folded phase, phase unwrapping is also required to obtain the true absolute phase, thereby solving the periodicity issue of the folded phase. To achieve global phase unwrapping, multiple image sequences or more complex spatial encoding and decoding processes are typically required. Shortening the single-scan duration can be achieved by reducing the number of images in a sequence and shortening the decoding algorithm time. In structured light encoding and decoding algorithms, the dependence on adjacent domain pixel information of images is the key to the integrity of single-scan data. In the process of determining the encoding value for a single pixel, considering more adjacent domain pixel information typically enhances the decoding accuracy. Therefore, sufficient encoding information is required within adjacent domain pixel range. However, due to the rich contour information on the tooth surface, including gingival grooves, interdental spaces, occlusions from adjacent teeth, and narrow tooth spaces, intraoral images exhibit a large amount of discontinuous surface information and structured light patterns. This leads to the loss of adjacent domain pixel information, resulting in decoding failures at those pixel positions and thereby reducing the integrity of data in that region. Structured light decoding algorithms that rely on less adjacent domain information can significantly improve the challenge of incomplete data in a single scan, thereby greatly enhancing scanning efficiency.

Optical properties of the tooth surface determine that general optical three-dimensional scanning techniques are not applicable, such as the phase-shift method used by dental model three-dimensional scanners. Specific enamel on tooth surface presents a significant challenge to optical measurement methods, as this enamel has high light reflection, light transmission, and light scattering. High light reflection generally reduces the dynamic range of object imaging, and needs to use different viewing angles to avoid the impact of light reflection on three-dimensional reconstruction. Light transmission and light scattering can seriously reduce the overall signal-to-noise ratio of object imaging and reduce the intensity of the light, and change the incident point of the light, which affects the depth information of the three-dimensional reconstruction. A method for trying to change optical characteristics of teeth is to apply solid powder spraying or liquid coating on teeth and gums, use the powder or coating to shield incident light, and control the thickness of the powder or coating so as to restore three-dimensional information about the tooth surface beneath the coating. However, both the powder and the coating are inconvenient, for example, patients may be allergic to or unable to tolerate them, which can also prolong the scanning time. The thickness of the powder or coating directly affects the accuracy of the three-dimensional data, potentially concealing defects of the tooth surface and unable to obtain the true tooth color. By means of the method, dynamic real-time three-dimensional scanning with color textures is directly performed on materials with characteristics such as high light reflection, light transmission and light scattering, such as teeth and gums inside the mouth.

In step S202, the projected pattern uses a randomly truncated binarized stripe having start and end features as the active light pattern, the advantage of this pattern is that it can maintain the features of the stripes (such as the stripe center or edge) even with the diffusion of the enamel; furthermore, using the randomly truncated pattern serves as decoding information, by utilizing spatial encoding schemes to reduce the complexity of the optical structure, the goal of three-dimensional reconstruction can be achieved with single-frame projection and acquisition, facilitating recognition and improving recognition accuracy.

In practical application scenarios, an oral scanning system may be used, including: a projection optical system, an image acquisition optical system, a timing control circuit, a heat dissipation system, a heating anti-fog system, a software algorithm system, etc. The timing control circuit triggers the projection optical system to project white light or a designed pattern onto the object to be measured (such as teeth or gums), and simultaneously controls the image acquisition optical system (such as one or more CCD chips) to rapidly acquire an image of the object to be measured with the projected pattern containing encoding information. The software algorithm is used to process the acquired images to obtain the three-dimensional data, with color textures, of the object to be measured. The heating anti-fog system eliminates fogging defects caused by the temperature difference between the inside of the mouth and the surrounding environment, while the heat dissipation system is used to maintain the overall temperature of the system. This system enables the direct acquisition of three-dimensional surface data of teeth inside the mouth without the need for powder spraying, and solves the problem of affecting image clarity and three-dimensional measurement due to the characteristics of tooth enamel, such as high light reflection, light transmission, and light scattering. The projection optical system in this system can use a custom DLP projector or a transmissive projection lens. In consideration of low costs, the present system uses the transmissive projection lens, thereby greatly reducing the manufacturing costs of the whole system.

In step S204, the positions of the feature points in the image may be found by extracting the centers of the binarized stripes or edges of the stripes, and using template matching. Specifically, the center or edges of the stripe are extracted, and the positions of the stripe start and end points are located (features such as a short horizontal line, a sphere, a cross and a square); at the same time, feature positions, such as a short horizontal line, a sphere, a cross and a square, in the image need to be found by means of template matching, and are identified, sorted and recorded.

In step S206, before matching the feature points in the first image and the second image, the two original images actually acquired by the camera can also be rectified using calibration parameters to align the image array rows, thereby improving the efficiency of image matching search, and converting the original two-dimensional search into one-dimensional search to achieve binocular stereo vision image distortion correction. In the actual matching process, the epipolar constraint of binocular stereo vision can also be used to verify the matching relationship of the start and end points, eliminating points and line segments that have high a matching degree but do not satisfy the epipolar constraint. It is also possible to arrange the positions of the feature points using random numbers, so as to achieve that there are no repeated feature positions in each column of the array pattern. By using the relation of the epipolar constraint, points having a high correlation matching degree but failing to satisfy the epipolar constraint can be removed, thereby reducing invalid data.

In step S208, the triangulation imaging principle can be utilized to perform three-dimensional reconstruction on subpixel-level stripe centers or stripe edges for points on line segments that meet the conditions. In a practical application scenario, taking tooth reconstruction in the oral cavity as an example, complete three-dimensional tooth topography data and texture information are generated for a plurality of scanned three-dimensional tooth topography in combination with a real-time splicing fusion technology.

In some embodiments of the present application, by means of the method of using a projected pattern composed of randomly distributed binarized stripes at least containing feature points to scan the object to be measured, the purpose of completing the encoding and decoding of the object to be measured using fewer sequence images is achieved, thereby realizing the technical effect of shortening the time required for encoding and decoding the object to be measured, and thus solving the technical problem in the related art of low image scanning efficiency.

Furthermore, the method provided in the present application uses the encoding and decoding technology that a projection pattern uses a randomly truncated binary stripe having start and end features as the active light pattern, and adopts a spatial encoding-based stripe extraction algorithm, merely one two-dimensional image is required to achieve three-dimensional reconstruction, which greatly reduces the camera frame rate and the computational cost of the algorithm. Therefore, compared to existing time encoding-based three-dimensional reconstruction methods that are difficult to implement real-time handheld scanning and require high-frame-rate cameras and high-speed algorithm support, the method in the embodiments of present application facilitates real-time handheld scanning, and significantly reduces the requirements for camera frame rate and algorithms. The method provided in the present application eliminates the need for dynamic projection, simplifying the original projection system (such as DLP and LCOS) into a transmission projection design scheme, which greatly reduces hardware costs, and therefore, the costs of hardware processing are significantly reduced compared with a method based on a microscopic confocal three-dimensional imaging principle in the related art.

In order to enable a person skilled in the art to understand the technical solutions of the present application more clearly, the implementation process of the method for three-dimensional reconstruction of the present application is described in details with reference to specific embodiments as below.

In step S202, binarized stripes in the projected pattern at least include the following representation forms: line segment stripes with endpoints as feature points and binarized stripes with feature points randomly distributed on the stripes, the binarized stripes are arranged according to predetermined distribution rules to form the projected pattern, wherein the line segment stripes are random in length, and the feature points at least include one of the following shapes: a horizontal line of a preset length, a spherical shape, a cross shape and a square shape.

It should be noted that, the shape features of the foregoing feature points are merely exemplary, and are not limited to the foregoing several shape features, for example, a triangle, an oval, a circle, a hexagon, a pentagon, a T shape, and a special shape.

In some embodiments of the present application, the projected pattern may also include a pattern using a combination of binarized stripes in various forms, for example, vertical stripe segments of a first preset length in a vertical direction and horizontal stripe segments of a second preset length in a horizontal direction are combined to form grid-like line segment stripes. In yet some embodiments of the present application, the oblique angles of the line segment stripes are adjusted, so as not to be completely vertical and horizontal, for example, a plurality of line segment stripes inclined at a preset angle constitute a projected pattern.

The predetermined distribution rules include, but are not limited to, the following manners: determining a first distribution rule for the binarized stripes from a plurality of horizontal distribution rules included in the predetermined distribution rules, wherein the plurality of horizontal distribution rules includes at least one of the following: horizontal spacings between laterally adjacent binarized stripes being equal, the horizontal spacings between the laterally adjacent binarized stripes being successively increased at equal intervals, and the horizontal spacings between the laterally adjacent binarized stripes being randomly selected from a preset distance interval; determining a second distribution rule for the binarized stripes from the predetermined distribution rules according to the types of the binarized stripes; and arranging the binarized stripes according to the first distribution rule and the second distribution rule to form the projected pattern.

The second distribution rule include, but are not limited to, the following manners: in cases where the binarized stripes in the projected pattern are line segment stripes, selecting a second distribution rule from a plurality of vertical distribution rules included in the predetermined distribution rules, wherein the plurality of vertical distribution rules include at least one of the following: vertical spacings between longitudinally adjacent line segment stripes being equal, the vertical spacings between the longitudinally adjacent line segment stripes being successively increased at equal intervals, and the vertical spacings between the longitudinally adjacent line segment stripes being randomly selected from a preset distance interval; and in cases where the binarized stripes in the projected pattern are binarized stripes in which feature points are randomly distributed on stripes, selecting a second distribution rule from a plurality of feature point distribution rules included in the predetermined distribution rules, wherein the plurality of feature point distribution rules at least includes: spacings between a plurality of feature points being equal, and the plurality of feature points being randomly distributed on stripes.

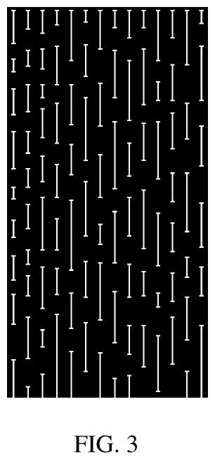

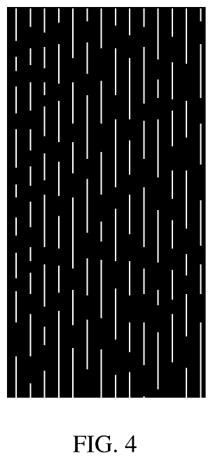

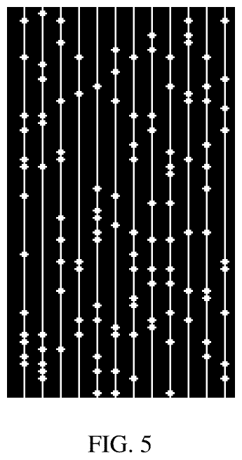

FIGS. 3-5 respectively show schematic diagrams of a projected pattern. As shown in FIG. 3, the projected pattern is formed by randomly distributing a plurality of line segment stripes of random lengths, and an end point (a feature point) of each line segment stripe is a horizontal line of a preset length. As shown in FIG. 4, the projected pattern is formed by randomly distributing a plurality of line segment stripes of random lengths. As shown in FIG. 5, the projected pattern consists of a plurality of binarized stripes distributed randomly, and a plurality of spherical feature points are distributed randomly on each binarized stripe.

It should be noted that FIGS. 3-5 merely exemplarily show three types of projected patterns, rather than all patterns, and thus the projected pattern of the present application is not limited to the projected patterns shown in FIGS. 3-5. For example, vertical stripe segments of a first preset length in a vertical direction and horizontal stripe segments of a second preset length in a horizontal direction are combined to form grid-like line segment stripes. In yet some embodiments of the present application, the oblique angles of the line segment stripes are adjusted, so as not to be completely vertical and horizontal, for example, a plurality of line segment stripes inclined at a preset angle constitute a projected pattern.

It should be understood that the projected pattern may be randomly or regularly formed according to the characteristics of binarized stripes, for example, the feature points are replaced with a cross shape and a square shape; the feature points are replaced with an oval shape and a hexagon shape; the lengths of line segment stripes are adjusted; the inclination angle is changed; the combination mode is changed; and the distribution rule and other characteristics are changed. In addition, the projected pattern of the present application can further include encoding information that can be added to the characteristics of binarized stripes.

In step S204, the corresponding adjacent domains of the feature points in the first image and the second image may be determined in the following manner: taking the feature points in the first image as an example, determining, from the first image, feature points to be matched; determining a sub-image window of a preset size from the first image by using the feature points to be matched as a center; and determining regions delimited by the sub-image window as the first adjacent domains.

In some embodiments of the present application, a feature point in the first image is taken as a center, a sub-image window having a size of M×N is referred to as an adjacent domain window of the feature point; an area defined by the adjacent domain window is determined as an adjacent domain; and a second adjacent domain corresponding to the second image is determined in a manner similar to that of the first image, which is not described herein again.

There are many methods for matching feature points in the first image and the second image, for example, a mean absolute difference algorithm (MAD), a sum of absolute differences algorithm (SAD), a sum of squared differences algorithm (SSD), a mean squared difference algorithm (MSD), a normalized cross-correlation algorithm (NCC), a sequential similarity detection algorithm (SSDA), and a hadamard transform algorithm (SATD).

In some embodiments of the present application, a normalized cross correlation manner may be used to complete pixel-level fast matching, for example, take determining features point in the second image that match the feature points in the first image as an example, first adjacent domains corresponding to the feature points to be matched in the first image are determined; a second adjacent domain corresponding to each feature point in the second image is sequentially determined; and matching degrees between the feature points to be matched and each feature point in the second image are determined according to grayscale values of the feature points to be matched, a grayscale value of each feature point in the second image, an average grayscale value of the first adjacent domains corresponding to the feature points to be matched, and an average grayscale value of the second adjacent domain corresponding to each feature point in the second image; and a feature point having the highest matching degree and meeting an epipolar constraint condition is selected from the second image, and is taken same as feature points matching the feature points to be matched in the second image.

A sub-image window centered on a feature in the image and having a size of m×n is called as a adjacent domain window of the feature point. It is assumed that (x, y) is the horizontal coordinate and vertical coordinate position of an image, S(x, y) is a similarity degree between two adjacent domain windows corresponding to (x, y), I(x, y) is a grayscale value of a target image at (x, y), and I is an average grayscale value of the adjacent domain windows of the target image; T(x, y) is a grayscale value of a source image at (x, y), and T is an average grayscale value of adjacent domain windows of the source image. When searching the right image for the correspondence of feature points in the left image, the right image serves as the target image, while the left image serves as the source image, and vice versa, then the similarity calculation is expressed by using the following formula:

$$S ( x , y ) = \frac{{{\sum }^{n - 1}}_{{y}^{′} = 0} {{\sum }^{m - 1}}_{{x}^{′} = 0} T ( {x}^{′} , {y}^{′} ) I ( x + {x}^{′} , y + {y}^{′} )}{\sqrt{{{\sum }^{n - 1}}_{{y}^{′} = 0} {{\sum }^{m - 1}}_{{x}^{′} = 0} T ( {x}^{′} , {y}^{′} ) {{\sum }^{n - 1}}_{{y}^{′} = 0} {{\sum }^{m - 1}}_{{x}^{′} = 0} {I ( x + {x}^{′} , y + {y}^{′} )}^{2}}}$$

where point (x′, y′) and point (x+x′, y+y′) are points within the adjacent domain window of the point (x, y), 0<x′<m, 0<y′<n.

It can be understood that intrinsic and extrinsic parameters of the binocular camera can be determined by the following manner, including: extracting feature point coordinates from an image in a calibration board collected by the binocular camera; calculating the intrinsic and extrinsic parameters of the binocular camera according to the feature point coordinates of the image in the calibration board, wherein the specific steps of the above described step include: determining, among a plurality of intrinsic and extrinsic parameters of the binocular camera, target parameters needing to be calibrated, wherein the target parameters include a rotation angle and a translation displacement for transforming a plurality of feature points of the image in the calibration board from a world coordinate system to a camera coordinate system, a camera focal length and a radial distortion coefficient; substituting three-dimensional coordinates of the plurality of feature points of the image in the calibration board and corresponding image coordinates into a preset system of linear equations to determine an optimal solution of the preset system of linear equations; and determining the target parameters on the basis of the optimal solution, wherein determining the target parameters on the basis of the optimal solution includes: determining, on the basis of the optimal solution, an x-axis component and a y-axis component in a rotation matrix corresponding to the rotation angle and an x-axis component and a y-axis component in a translation matrix corresponding to the translation displacement; sequentially determining the camera focal length and the radial distortion coefficient on the basis of the x-axis component and the y-axis component in the rotation matrix and the x-axis component and the y-axis component in the translation matrix.

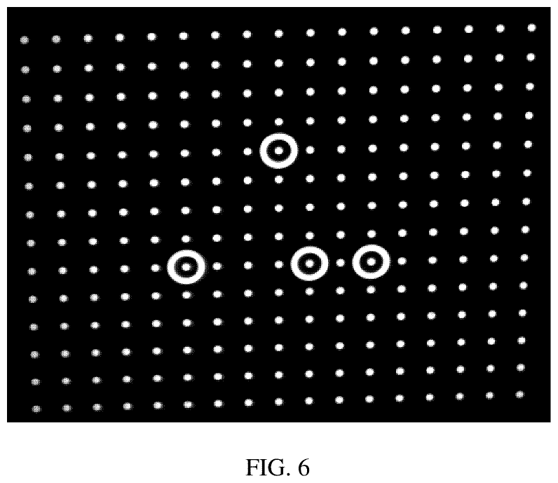

In practical application scenarios, the process of dual-target calibration and light plane calibration involves connecting a calibration board to a motor by means of a shaft, while maintaining the calibration board plane at a certain angle (e.g., 30°) with the optical axis of the camera. The motor is controlled to drive the calibration board to perform parallel rotational motion along the axis, while the camera is synchronously controlled to capture images of the calibration board and extract feature point coordinates; and an iterative optimization for calibration is performed using multiple sets of feature point coordinates to calculate internal and external parameters of the camera. This process requires only clicking the start button to achieve synchronized movement of the calibration board and image acquisition, while simultaneously performing feature extraction. Once acquisition is complete, automatic optimization calculation proceeds until the calibration result is obtained. In camera calibration work, there are six external parameters that need to be calibrated: the rotation angles around the three coordinate axes in the rotation matrix, and the displacements along the three coordinate axes in the translation matrix; there are six internal parameters that need to be calibrated: i.e., Cₓ, C_{y}, Sₓ, S_{y}, f and k, where (Cₓ, C_{y}) are the coordinates of the center of the acquired image; Sₓ, S_{y} are respectively the number of pixels per unit distance (in pixels/mm) in the X and Y directions on the image plane, which are the scaling factors. In addition, Sₓ/S_{y}=β, where β is a scale factor. Cₓ, C_{y} and S_{y} have been determined by means of pre-calibration. Therefore, only Sₓ, the effective focal length f, and the radial distortion coefficient k among the six external parameters need to be solved here. In the process of performing calibration by a scanner, a binocular stereo vision imaging principle is used to perform stereo matching on extracted circle center coordinates as feature points; a triangulation imaging principle is used to reconstruct the three-dimensional coordinates of each feature point; and then information related to a difference value and a gradient is used to acquire a dense point cloud; and the pattern of the calibration board is as shown in FIG. 6, with the circle diameters and spacings all being standard values. The method of center fitting is used to extract the coordinates of the centers of the circles shown in the figure. By using multiple images of the calibration board, the two-dimensional coordinates of the coordinates of circle center of the calibration board are obtained; and then the internal and external parameters of a video camera are calculated to complete a calibration algorithm process.

In some embodiments of the present application, the embodiments of the present application adopt a camera model based on first-order radial distortion, utilizing a step-by-step decomposition camera linear calibration method to decompose the parameters progressively. By solving linear equation sets, the rotation matrix is first calculated, then the translation matrix is calculated, and finally the internal parameter focal length and the radial distortion coefficient are calculated. It is specifically derived as follows:

according to the theory of projection and perspective transformation, and matrix transformation knowledge, the complete transformation from a three-dimensional world coordinate system to a computer image coordinate system can be divided into four steps:
(1) the transformation from a three-dimensional space coordinate system to a camera coordinate system, i.e., from (x_{w}, y_{w}, z_{w}) to (x, y, z).

$$wherein , [ \begin{matrix}x \\ y \\ z\end{matrix} ] = R [ \begin{matrix}{x}_{w} \\ {y}_{w} \\ {z}_{w}\end{matrix} ] + T , \qquad formula ( 2.3 )$$

R and T represent the rotation and translation transformations from the world coordinate system to the camera coordinate system. R is a 3×3 orthogonal matrix, and T is a 3×1 translation vector, with a total of six independent variables, i.e., three rotation angles reflecting the rotational transform and three translation components reflecting the translation transform.
   Wherein

$$R = [ \begin{matrix}cos ψ cos θ & cos ψ sin θ sin φ - sin ψ cos φ & cos ψ sin θ cos φ - sin ψ sin φ \\ sin ψ cos θ & sin ψ sin θ sin φ + cos ψ cos φ & sin ψ sin θ cos φ + cos ψ sin φ \\ - sin θ & cos θ sin φ & cos θ cos φ\end{matrix} ] ,$$

$$and$$

$$T = [ \begin{matrix}{T}_{x} & {T}_{y} & {T}_{z}\end{matrix} ] .$$

(2) The ideal perspective projection transformation under the pinhole camera model, i.e., transformation from (x, y, z) to (Xᵤ, Yᵤ).
wherein

$${X}_{u} = f \frac{x}{z} ,$$

formula (2.4); and

$${Y}_{u} = f \frac{y}{z} ,$$

formula (2.5).
(3) Distortion model: describing a relationship between the actual image coordinates (X_{d}, Y_{d}) and the ideal image coordinates (Xᵤ, Yᵤ) in an image coordinate system. Most experiments prove that the distortion at the central point of the image is small, and the distortion at the edge of the image is large, therefore, kR_{d}² is selected as a distortion factor to establish the following distortion model: wherein X_{d}=(1+kR_{d}²)Xᵤ, formula (2.6); Y_{d}=(1+kR_{d}²)Yₙ, formula (2.7);

$${R}_{d}^{2} = {X}_{d}^{2} + {Y}_{d}^{2} , {R}_{d}$$

is the square of the radial radius, and k is the radial distortion coefficient.
(4) Transformation of actual image coordinates into computer image coordinates, i.e., from (X_{d}, Y_{d}) to (X_{f}, Y_{f}).
wherein X_{f}=Cₓ+SₓX_{d} formula (2.8); and Y_{f}=C_{y}+S_{y} Y_{d}, formula (2.9), (Cₓ, C_{y}) are the coordinate of the center of the computer frame buffer image (acquired image), and Sₓ, S_{y} represent the number of pixels per unit distance (in pixels/mm) in the X and Y directions on the image plane, which are the scaling factors.

$$Let {S}_{x} / {S}_{y} = β ; {X}_{d} ’ = ( {X}_{f} - {C}_{x} ) / {S}_{y} ; then {X}_{d} = {X}_{d} ’ / β .$$

It can be seen that the parameters needing to be calibrated include:
external parameters: R and T share six independent variables;
internal parameters: f is an effective focal length, k is a radial distortion coefficient, Sₓ and S_{y} are respectively scaling factors in X and Y directions, β is an scale factor, (Cₓ, C_{y}) are the coordinate of the center of the computer frame buffer image.
Cₓ, C_{y} and S_{y} may be obtained by pre-calibration.

Let a rotation matrix

$$R = [ \begin{matrix}{r}_{1} & {r}_{2} & {r}_{3} \\ {r}_{4} & {r}_{5} & {r}_{6} \\ {r}_{7} & {r}_{8} & {r}_{9}\end{matrix} ] ,$$

and a translation matrix

$$T = [ \begin{matrix}{T}_{x} \\ {T}_{y} \\ {T}_{z}\end{matrix} ] ;$$

rotation matrices R and the Tₓ and T_{y} components of the T are calculated.

$$\frac{x}{y} = \frac{{r}_{1} {x}_{w} + {r}_{2} {y}_{w} + {r}_{3} {z}_{w} + {T}_{x}}{{r}_{4} {x}_{w} + {r}_{5} {y}_{w} + {r}_{6} {z}_{w} + {T}_{y}} .$$

is obtained from formulas (2.3), and

$$\frac{{X}_{d}}{{Y}_{d}} = \frac{{X}_{u}}{{Y}_{u}} = \frac{x}{y} = \frac{{{X}_{d}}^{′}}{β {Y}_{d}}$$

is obtained from formulas (2.4), (2.5), (2.6) and (2.7).

Hence,

$$\frac{{{X}_{d}}^{′}}{β {Y}_{d}} = \frac{{r}_{1} {x}_{w} + {r}_{2} {y}_{w} + {r}_{3} {z}_{w} + {T}_{x}}{{r}_{4} {x}_{w} + {r}_{5} {y}_{w} + {r}_{6} {z}_{w} + {T}_{y}} .$$

By rearranging the formula and shifting terms,

$$[ \begin{matrix}{x}_{w} {Y}_{d} & {y}_{w} {Y}_{d} & {z}_{w} {Y}_{d} & {Y}_{d} & - {x}_{w} {{X}_{d}}^{′} & - {y}_{w} {{X}_{d}}^{′} & - {z}_{w} {{X}_{d}}^{′}\end{matrix} ] [ \begin{matrix}\frac{{r}_{1} β}{{T}_{y}} \\ \frac{{r}_{2} β}{{T}_{y}} \\ \frac{{r}_{3} β}{{T}_{y}} \\ \frac{{t}_{x} β}{{T}_{y}} \\ \frac{{r}_{4}}{{T}_{y}} \\ \frac{{r}_{5}}{{T}_{y}} \\ \frac{{r}_{6}}{{T}_{y}}\end{matrix} ] = {{X}_{d}}^{′}$$

is obtained.

In some embodiments of the present application, for each calibration point, when its three-dimensional coordinates and corresponding image coordinates are known, an equation as described above can be formed. In the above equation of X_{d}, the seven elements of the column vector are unknowns. By selecting seven calibration points and solving the linear system of equations, these seven unknowns can be determined. Considering that there is a random error in the values of the three-dimensional coordinate point and the image coordinate during the calibration process, more calibration points (>7) should be selected. According to the principle of the least squares method, the optimal solution that minimizes the total error across all calibration points can be obtained. Then, on the basis of the orthogonal property of the rotation matrix R, the elements of the rotation matrix R, as well as Tₓ and T_{y}, can be further calculated.

In some embodiments of the present application, by using the least squares method to solve the overdetermined system of equations (N≥7), the following variables can be obtained:

$${α}_{1} = \frac{{r}_{1} β}{{T}_{y}} ; {α}_{2} = \frac{{r}_{2} β}{{T}_{y}} ; {α}_{3} = \frac{{r}_{3} β}{{T}_{y}} ; {α}_{4} = \frac{{t}_{x} β}{{T}_{y}} ; {α}_{5} = \frac{{r}_{4}}{{T}_{y}} ; {α}_{6} = \frac{{r}_{5}}{{T}_{y}} ; {α}_{7} = \frac{{r}_{6}}{{T}_{y}} .$$

In some embodiments of the present application, by using the orthogonality (standard orthogonal matrix) of R, B, T_{y}, Tₓ, r₁, and r₂ can be calculated as follows:
(1) |T_{y}| is calculated, wherein |T_{y}|=(α₅²+α₆²+α₇²)^{1/2}.
(2) β and Sₓ are calculated, wherein β=(α₁²+α₂²+α₃²)^{1/2}|T_{y}|, then Sₓ=BS_{y}.
(3) After |T_{y}| is obtained, the sign of T_{y} still needs to be determined. Actually, from imaging geometry, it is known that X_{d} and x have the same sign, and Y_{d} and y also have the same sign. This can be used to determine the sign of T_{y}. That is, after |T_{y}| is obtained, any feature point PK (xₖ, yₖ, zₖ) is selected. First, assume T_{y} is positive, then the variables solved from the above overdetermined system (N≥7) can be used to calculate r₁ to r₆ and Tₓ.

In some embodiments of the present application, the feature points corresponding to x and y may be calculated. If, in this case, x and X_{d}, as well as, y and Y_{d}, have the same sign, then the sign of T_{y} is positive; otherwise, the sign of T_{y} is negative.
(4) Given T_{y} and β, the variables solved from the above overdetermined system of equations (N≥7) can be used to directly calculate r₁ to r₆ and Tₓ. Using the orthogonality of R and the right-hand coordinate system property (corresponding to the world coordinate system is a right-hand coordinate system), it can be determined that r₇ to r₉ are obtained by the cross-multiplication of the first two rows:

$${r}_{7} = {r}_{2} {r}_{6} - {r}_{3} {r}_{5} ; {r}_{8} = {r}_{3} {r}_{4} - {r}_{1} {r}_{6} ; {r}_{9} = {r}_{1} {r}_{5} - {r}_{2} {r}_{4} .$$

By means of the above process, the entire rotation matrices R, Tₓ and T_{y} components of T and image scale factor β have been solved.

In some embodiments of the present application, by calculating the effective focal length f, the T_{z} component of T, and the radial distortion coefficient k, the following may be calculated:

$${X}_{u} = \frac{{X}_{d}}{1 + {kR}_{d}^{2}} = f \frac{{r}_{1} {x}_{w} + {r}_{2} {y}_{w} + {r}_{3} {z}_{w} + {T}_{x}}{{r}_{7} {x}_{w} + {r}_{8} {y}_{w} + {r}_{9} {z}_{w} + {T}_{z}} ; and {Y}_{u} = \frac{{Y}_{d}}{1 + {kR}_{d}^{2}} = f \frac{{r}_{4} {x}_{w} + {r}_{5} {y}_{w} + {r}_{6} {z}_{w} + {T}_{y}}{{r}_{7} {x}_{w} + {r}_{8} {y}_{w} + {r}_{9} {z}_{w} + {T}_{z}} .$$

It is assumed that:

$$\begin{matrix}{H}_{x} = {r}_{1} {x}_{w} + {r}_{2} {y}_{w} + {r}_{3} {z}_{w} + {T}_{x} , \\ {H}_{y} = {r}_{4} {x}_{w} + {r}_{5} {y}_{w} + {r}_{6} {z}_{w} + {T}_{y} , and \\ W = {r}_{7} {x}_{w} + {r}_{8} {y}_{w} + {r}_{9} {z}_{w} , {f}_{k} = f \cdot k ,\end{matrix}$$

it can be obtained that:

$${H}_{x} \cdot f + {H}_{x} {r}_{d}^{2} \cdot {f}_{k} - {X}_{d} \cdot {T}_{z} = {X}_{d} \cdot W , {H}_{y} \cdot f + {H}_{x} {r}_{d}^{2} \cdot {f}_{k} - {Y}_{d} \cdot {T}_{z} = {Y}_{d} \cdot W .$$

In some embodiments of the present application, for N feature points, joint optimal parameter estimation can be performed on the described two equations using a least-squares method to obtain f, fₖ and T_{z}, thereby obtain f, k and T_{z}.

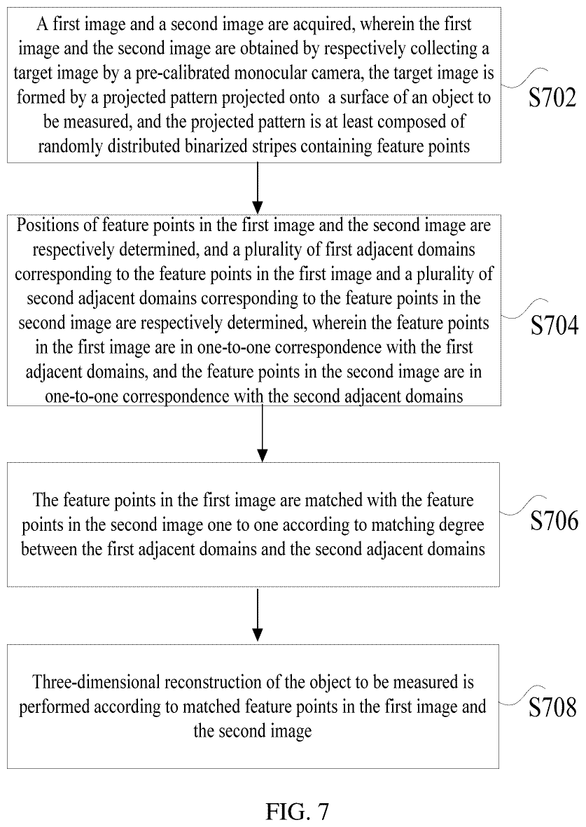

According to another aspect of the present application, also provided is a method for three-dimensional reconstruction, as shown in FIG. 7, including:
step S702: a first image and a second image are acquired, wherein the first image and the second image are obtained by respectively collecting a target image by a pre-calibrated monocular camera, the target image is formed by a projected pattern projected onto a surface of an object to be measured, and the projected pattern is at least composed of randomly distributed binarized stripes containing feature points;
step S704: positions of feature points in the first image and the second image are respectively determined, and a plurality of first adjacent domains corresponding to the feature points in the first image and a plurality of second adjacent domains corresponding to the feature points in the second image are respectively determined, wherein the feature points in the first image are in one-to-one correspondence with the first adjacent domains, and the feature points in the second image are in one-to-one correspondence with the second adjacent domains;
step S706: the feature points in the first image are matched with the feature points in the second image one to one according to matching degree between the first adjacent domains and the second adjacent domains; and
step S708: three-dimensional reconstruction of the object to be measured is performed according to matched feature points in the first image and the second image.

In some embodiments of the present application, the target image can be acquired at different moments respectively by means of the monocular camera, to obtain the first image and the second image; or the target image is acquired by means of the monocular camera to obtain the first image, and the first image is modulated to obtain the second image.

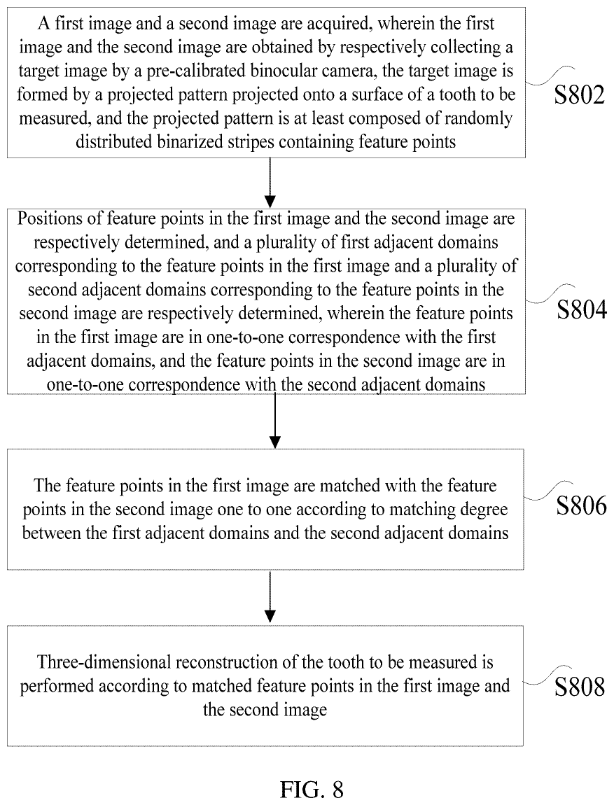

According to still another aspect of the present application, also provided is a method for three-dimensional reconstruction of intraoral teeth, as shown in FIG. 8, including:
step S802: a first image and a second image are acquired, wherein the first image and the second image are obtained by respectively collecting a target image by a pre-calibrated binocular camera, the target image is formed by a projected pattern projected onto a surface of a tooth to be measured, and the projected pattern is at least composed of randomly distributed binarized stripes containing feature points;
step S804: positions of feature points in the first image and the second image are respectively determined, and a plurality of first adjacent domains corresponding to the feature points in the first image and a plurality of second adjacent domains corresponding to the feature points in the second image are respectively determined, wherein the feature points in the first image are in one-to-one correspondence with the first adjacent domains, and the feature points in the second image are in one-to-one correspondence with the second adjacent domains;
step S806: the feature points in the first image are matched with the feature points in the second image one to one according to matching degree between the first adjacent domains and the second adjacent domains; and
step S808: three-dimensional reconstruction of the tooth to be measured is performed according to matched feature points in the first image and the second image.

In a practical application scenario, the epipolar constraint of binocular stereo vision can also be used to verify the matching relationship of the start and end points, eliminating points and line segments that have high a matching degree but do not satisfy the epipolar constraint. Because the repeatability problem of the start and stop points of the features is considered when designing the structured light pattern, the positions of the feature points are arranged using random numbers, so as to achieve that there are no repeated feature positions in each column of the array pattern. By using the relation of the epipolar constraint, points having a high correlation matching degree but failing to satisfy the epipolar constraint can be removed, thereby reducing the generation of miscellaneous data.

It should be noted that, based on the method and projected pattern in any of the above embodiments, it can be configured as medical scanners such as oral scanners, as well as industrial-grade scanners, professional-grade scanners, facial scanners, desktop scanners, and various other types of scanners. It has no restrictions on scanning scenarios, and the scanning scenario may be set to a tooth scanning scenario, and may also be set to a variety of scenarios such as industrial products, cultural relics, racing cars, aerospace components, clothing, and human faces.

Embodiments of the present application further provide an apparatus for three-dimensional reconstruction. It should be noted that, the apparatus for three-dimensional reconstruction of the embodiments of the present application may be configured to execute the method for three-dimensional reconstruction provided in some embodiments of the present application. The apparatus is used for implementing the described embodiments and preferred embodiments, and what has been described will not be repeated again. As used below, the term “component” may implement a combination of software and/or hardware of predetermined functions. Although the apparatus described in the following embodiments is preferably implemented in software, implementation in hardware or a combination of software and hardware is also possible and conceived.

Hereinafter, the apparatus for three-dimensional reconstruction provided in the embodiments of the present application is introduced.

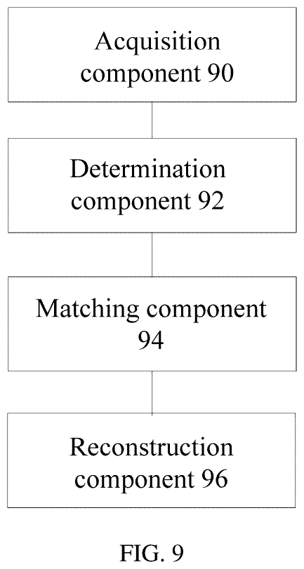

FIG. 9 is a schematic diagram of an apparatus for three-dimensional reconstruction according to some embodiments of the present application. As shown in FIG. 9, the apparatus includes: an acquisition component 90, configured to acquire a first image and a second image, wherein the first image and the second image are obtained by respectively collecting a target image by a pre-calibrated binocular camera, the target image is formed by a projected pattern projected onto a surface of an object to be measured, and the projected pattern is at least composed of binarized stripes containing feature points; a determination component 92, configured to respectively determine positions of feature points in the first image and the second image, and respectively determine a plurality of first adjacent domains corresponding to the feature points in the first image and a plurality of second adjacent domains corresponding to the feature points in the second image, wherein the feature points in the first image are in one-to-one correspondence with the first adjacent domains, and the feature points in the second image are in one-to-one correspondence with the second adjacent domains; a matching component 94, configured to match the feature points in the first image with the feature points in the second image one to one according to matching degree between the first adjacent domains and the second adjacent domains; and a reconstruction component 96, configured to perform three-dimensional reconstruction of the object to be measured according to matched feature points in the first image and the second image.

The acquisition component 90 includes a projection sub-component configured to determine types of the binarized stripes, wherein the types of the binarized stripes at least include one of the following: line segment stripes with endpoints as feature points and binarized stripes with feature points randomly distributed on stripes; and arrange the binarized stripes according to predetermined distribution rules to form the projected pattern, wherein the line segment stripes are random in length, and the feature points at least include one of the following shapes: a horizontal line of a preset length, a spherical shape, a cross shape and a square shape.

The projection sub-component includes a first determination unit and a second determination unit, wherein the first determination unit is configured to determine a first distribution rule for the binarized stripes from a plurality of horizontal distribution rules included in the predetermined distribution rules, wherein the plurality of horizontal distribution rules includes at least one of the following: horizontal spacings between laterally adjacent binarized stripes being equal, the horizontal spacings between the laterally adjacent binarized stripes being successively increased at equal intervals, and the horizontal spacings between the laterally adjacent binarized stripes being randomly selected from a preset distance interval; determine a second distribution rule for the binarized stripes from the predetermined distribution rules according to the types of the binarized stripes; and arrange the binarized stripes according to the first distribution rule and the second distribution rule to form the projected pattern.

The second determination unit is configured to select, in cases where the binarized stripes in the projected pattern are line segment stripes, a second distribution rule from a plurality of vertical distribution rules included in the predetermined distribution rules, wherein the plurality of vertical distribution rules includes at least one of the following: vertical spacings between t longitudinally adjacent line segment stripes being equal, the vertical spacings between the longitudinally adjacent line segment stripes being successively increased at equal intervals, and the vertical spacings between the longitudinally adjacent line segment stripes being randomly selected from a preset distance interval; and select, in cases where the binarized stripes in the projected pattern are binarized stripes in which feature points are randomly distributed on stripes, a second distribution rule from a plurality of feature point distribution rules included in the predetermined distribution rules, wherein the plurality of feature point distribution rules at least includes: spacings between a plurality of feature points being equal, and the plurality of feature points being randomly distributed on stripes.

The determination component 92, includes a adjacent domain sub-component and a feature point sub-component, wherein the adjacent domain sub-component is configured to determine, from the first image, feature points to be matched; determine a sub-image window of a preset size from the first image by using the feature points to be matched as a center; and determine regions delimited by the sub-image window as the first adjacent domains.

The feature point sub-component is configured to determine first adjacent domains corresponding to the feature points to be matched in the first image; sequentially determine a second adjacent domain corresponding to each feature point in the second image; and determine matching degrees between the feature points to be matched and each feature point in the second image according to grayscale values of the feature points to be matched, a grayscale value of each feature point in the second image, an average grayscale value of the first adjacent domains corresponding to the feature points to be matched, and an average grayscale value of the second adjacent domain corresponding to each feature point in the second image; and select, from the second image, a feature point having the highest matching degree and meeting an epipolar constraint condition, and take same as feature points matching the feature points to be matched in the second image.

The reconstruction component 96 includes an intrinsic and extrinsic parameter sub-component which is configured to extract feature point coordinates from an image in a calibration board collected by the binocular camera; and calculate the intrinsic and extrinsic parameters of the binocular camera according to the feature point coordinates of the image in the calibration board.

The internal and external parameter sub-component includes a calibration unit and a solving unit, wherein the calibration unit is configured to determine, among a plurality of intrinsic and extrinsic parameters of the binocular camera, target parameters needing to be calibrated, wherein the target parameters include a rotation angle and a translation displacement for transforming a plurality of feature points of the image in the calibration board from a world coordinate system to a camera coordinate system, a camera focal length and a radial distortion coefficient; substitute three-dimensional coordinates of the plurality of feature points of the image in the calibration board and corresponding image coordinates into a preset system of linear equations to determine an optimal solution of the preset system of linear equations; and determine the target parameters on the basis of the optimal solution.

The solving unit is configured to determine, on the basis of the optimal solution, an x-axis component and a y-axis component in a rotation matrix corresponding to the rotation angle and an x-axis component and a y-axis component in a translation matrix corresponding to the translation displacement; and sequentially determine the camera focal length and the radial distortion coefficient on the basis of the x-axis component and the y-axis component in the rotation matrix and the x-axis component and the y-axis component in the translation matrix.

The apparatus for three-dimensional reconstruction includes a processor and a memory, wherein the described units, etc. are all stored in the memory as program units, and the processor executes the described program units stored in the memory to realize corresponding functions. The components can be located in the same processor; or all the components above are located in different processors in any arbitrary combination manner.

The processor includes a kernel, and the kernel retrieves corresponding program units in the memory. One or more kernels may be provided, by adjusting kernel parameters, by means of the method of using a projected pattern composed of randomly distributed binarized stripe at least containing feature points to scan the object to be measured, the purpose of completing the encoding and decoding of the object to be measured using fewer sequence images is achieved, thereby realizing the technical effect of shortening the time required for encoding and decoding the object to be measured, and thus solving the technical problem in the related art of low image scanning efficiency.

The memory may comprise forms such as a non-permanent memory, a random access memory (RAM) and/or a non-volatile memory in a computer-readable medium, for example, a read-only memory (ROM) or a flash memory (flash RAM), and the memory comprises at least one memory chip.

The embodiments of the present application provide a computer non-transitory readable storage medium, including a program stored on the computer non-transitory readable storage medium; when the program runs, a device where the computer non-transitory readable storage medium is located is controlled to execute the method for three-dimensional reconstruction.

The embodiments of the present application provide an oral scanner. The oral scanner includes a processor, a memory, and a program stored on the memory and executable on the processor. When the processor executes the program, at least the following steps are implemented: acquiring a first image and a second image, wherein the first image and the second image are obtained by respectively collecting a target image by a pre-calibrated camera (a binocular camera or a monocular camera), the target image is formed by a projected pattern projected onto a surface of an object to be measured, and the projected pattern is at least composed of binarized stripes containing feature points; respectively determining positions of feature points in the first image and the second image, and respectively determining a plurality of first adjacent domains corresponding to the feature points in the first image and a plurality of second adjacent domains corresponding to the feature points in the second image, wherein the feature points in the first image are in one-to-one correspondence with the first adjacent domains, and the feature points in the second image are in one-to-one correspondence with the second adjacent domains; matching the feature points in the first image with the feature points in the second image one to one according to matching degree between the first adjacent domains and the second adjacent domains; and performing three-dimensional reconstruction of the object to be measured according to matched feature points in the first image and the second image.

The oral scanner may be an intraoral scanner or an extraoral scanner, and refers to a scanning device that can be configured to acquire oral data.

The embodiments of the present application provide a system for scanning oral cavity, including: a projection optical system, an image acquisition optical system and a software algorithm system. The projection optical system includes a light emission portion and a light transmission portion, wherein the light emission portion is configured to emit projection light, the light transmission portion is disposed on a light exit side of the light emission portion such that the projection light emitted from the light emission portion forms a projected pattern after passing through the light transmission portion, the projected pattern includes at least binarized stripes containing feature points. The image acquisition optical system includes one or more cameras for acquiring a projected pattern projected onto a surface of an object to be measured. The software algorithm system is configured to perform the method for three-dimensional reconstruction.

The embodiments of the present application provide a projection optical system. The projection optical system includes a light emission portion and a light transmission portion, wherein the light emission portion is configured to emit projection light, the light transmission portion is disposed on a light exit side of the light emission portion such that the projection light emitted from the light emission portion forms a projected pattern after passing through the light transmission portion, the projected pattern includes at least binarized stripes containing feature points.

In some embodiments of the present application, the projection optical system may adopt a customized DLP projector, the light transmission portion may be a DMD (Digital Micromirror Device) chip including a plurality of micromirrors, the projected pattern is generated by a software algorithm system, the final projected pattern is determined, and the micromirrors will be controlled to rotate so that the projection light emitted by the light transmission portion forms the projected pattern after passing through the light transmission portion.

In some embodiments of the present application, the software algorithm system generates the projected pattern by the following manner, including: determining types of the binarized stripes; and arranging the binarized stripes according to predetermined distribution rules to form the projected pattern.

In some embodiments of the present application, the projected pattern is determined by the following manners: determining types of the binarized stripes, wherein the types of the binarized stripes at least include one of the following: line segment stripes with endpoints as feature points and binarized stripes with feature points randomly distributed on stripes; and arranging the binarized stripes according to predetermined distribution rules to form the projected pattern, wherein the line segment stripes are random in length, and the feature points at least include one of the following shapes: a horizontal line of a preset length, a spherical shape, a cross shape and a square shape.

In some embodiments of the present application, arranging the binarized stripes according to the predetermined distribution rules to form the projected pattern includes: determining a first distribution rule for the binarized stripes from a plurality of horizontal distribution rules included in the predetermined distribution rules, wherein the plurality of horizontal distribution rules includes at least one of the following: horizontal spacings between laterally adjacent binarized stripes being equal, the horizontal spacings between the laterally adjacent binarized stripes being successively increased at equal intervals, and the horizontal spacings between the laterally adjacent binarized stripes being randomly selected from a preset distance interval; determining a second distribution rule for the binarized stripes from the predetermined distribution rules according to the types of the binarized stripes; and arranging the binarized stripes according to the first distribution rule and the second distribution rule to form the projected pattern.

In some embodiments of the present application, determining the second distribution rule for the binarized stripes from the predetermined distribution rules according to the types of the binarized stripes includes: in cases where the binarized stripes in the projected pattern are line segment stripes, selecting a second distribution rule from a plurality of vertical distribution rules included in the predetermined distribution rules, wherein the plurality of vertical distribution rules includes at least one of the following: vertical spacings between longitudinally adjacent line segment stripes being equal, the vertical spacings between the longitudinally adjacent line segment stripes being successively increased at equal intervals, and the vertical spacings between the longitudinally adjacent line segment stripes being randomly selected from a preset distance interval; and in cases where the binarized stripes in the projected pattern are binarized stripes in which feature points are randomly distributed on stripes, selecting a second distribution rule from a plurality of feature point distribution rules included in the predetermined distribution rules, wherein the plurality of feature point distribution rules at least includes: spacings between a plurality of feature points being equal, and the plurality of feature points being randomly distributed on stripes.

In some embodiments of the present application, the projection optical system may adopt a transmissive projection lens, the light transmission portion is a grating sheet (mask), including a photomask, and at least one shielding object is arranged on the photomask for shielding the projection light, and the photomask is used for shielding a light path of the projection light so that the light path of the projection light traverses from the coverage area of the photomask, so that the projection light emitted by the light transmission portion forms the projected pattern after passing through the light transmission portion.

In some embodiments of the present application, the photomask is configured to have a pattern in the photographic negative (or reverse) relationship to a desired projected pattern. Specifically, openings or light-transmitting objects are formed at positions on the photomask corresponding to the binarized stripes of the projected pattern, while the shielding object (opaque object) is provided at other positions. Thus, the photomask adjusts the projection light by selectively blocking the light path, allowing only light rays to transmit through the light-transmitting region. Consequently, the projection light passing through the photomask forms the designed projected pattern.

In some embodiments of the present application, the arrangement of the openings or light-transmitting objects on the photomask follows the distribution rules of the binarized stripes in the projected pattern.

In some embodiments of the present application, types of the binarized stripes at least include one of the following: line segment stripes with endpoints as feature points and binarized stripes with feature points randomly distributed on stripes; wherein the line segment stripes are random in length, and the feature points at least comprise one of the following shapes: a horizontal line of a preset length, a spherical shape, a cross shape and a square shape.

In some embodiments of the present application, a plurality of horizontal distribution rules of the binarized stripes include at least one of the following: horizontal spacings between laterally adjacent binarized stripes being equal, the horizontal spacings between the laterally adjacent binarized stripes being successively increased at equal intervals, and the horizontal spacings between the laterally adjacent binarized stripes being randomly selected from a preset distance interval.

In some embodiments of the present application, a plurality of vertical distribution rules of the binarized stripes include at least one of the following: vertical spacings between longitudinally adjacent line segment stripes being equal, the vertical spacings between the longitudinally adjacent line segment stripes being successively increased at equal intervals, and the vertical spacings between the longitudinally adjacent line segment stripes being randomly selected from a preset distance interval.

In some embodiments of the present application, the shielding object includes a plurality of line segment stripe shielding objects with random lengths. A plurality of line segment stripe shielding objects with random lengths are arranged on the photomask according to a preset rule, wherein the preset rule at least includes one of the following: horizontal spacings between laterally adjacent segment stripes being equal, the horizontal spacings between the laterally adjacent segment stripes being successively increased at equal intervals, and the horizontal spacings between the laterally adjacent segment stripes being randomly selected from a preset distance interval.

In some embodiments of the present application, the photomask has an area that is not less than a cross-sectional area of a beam of the projection light passing through the photomask, and the photomask is a monolithic photomask.

The projection optical system further includes a structural member for fixing the light transmission portion at a preset position in a light path of the projection light, the distance from the preset position to the light emission portion is proportional to a area of the light transmission portion.

The projection optical system further includes a housing, the housing is provided with at least two installation spaces for installing the light emission portion and the light transmission portion respectively, wherein a hole is arranged between the at least two installation spaces for laser light to pass through.

The projection optical system further includes a light convergence portion, the projection light includes a plurality of projection light rays, the light convergence portion is provided in the housing and provided on the light path of the projection light (transmission path of the projection light), wherein a plurality of projection light rays are projected to the light transmission portion in the same transmission path after being converged by the light convergence portion.

The light emission portion further includes any one of the following: multiple LED light sources, the light emission portion emitting the multiple laser light through the multiple LED light sources; and multiple laser emitters, the light emission portion emitting the multiple laser light through the multiple laser emitters.

When the light emission portion emits the multiple laser light through the multiple laser emitters, the projection optical system further includes a decoherence portion disposed on the transmission path of the laser light, wherein the multiple laser light is projected to the light transmission portion after diffraction spots are eliminated through the decoherence portion.

The decoherence portion includes: a phase modulation element, disposed on the transmission path of the laser light and rotating around a preset axis, wherein the transmission path of the laser light is parallel to the preset axis of the phase modulation element; and a beam coupling element, disposed on the transmission path of the laser light and configured to perform collimation adjustment on the laser light and reduce a divergence angle of the laser light, wherein the decoherence portion eliminates the diffraction spots of the laser light through the phase modulation element and the beam coupling element.

When the light emission portion emits the multiple laser light through the multiple laser emitters, the projection optical system further includes a solid dielectric element disposed on the transmission path of the laser light, wherein the laser light is projected to the light transmission portion after being subjected to multiple reflection mixing by the solid dielectric element.

Obviously, those skilled in the art should understand that the components or steps in the present application can be implemented by using a general computing device, and they can be integrated in a single computing device, and can also be distributed over a network consisting of a plurality of computing devices. They may be implemented by using executable program codes of the computing devices. Thus, they can be stored in a storage device and executed by the computing devices. Furthermore, in some cases, the shown or described steps may be executed in an order different from that described here, or they can be respectively implemented by individual Integrated Circuit modules, or they can be implemented by making a plurality of the modules or steps into a single Integrated Circuit module. Hence, the present application is not limited to any specific combinations of hardware and software.

As will be appreciated by a person skilled in the art, embodiments of the present application may be provided as a method, a system, or a computer program product. Therefore, the present application may take the form of entirely hardware embodiments, entirely software embodiments or embodiments combining software and hardware. Furthermore, the present application may take the form of a computer program product implemented on one or more computer-usable storage media (including but not limited to a disk memory, a CD-ROM, an optical memory, etc.) containing computer-usable program codes.

Some embodiments of the present application are described with reference to the flowcharts and/or block diagrams of the method, device (system), and computer program product according to the embodiments of the present disclosure. It should be understood that computer program instructions may be used to implement each process and/or block in the flowchart and/or block diagram and a combination of processes and/or blocks in the flowchart and/or the block diagram.

These computer program instructions may be provided to a processor of a general-purpose computer, a special-purpose computer, an embedded processor or other programmable data processing devices to produce a machine, such that an apparatus for implementing functions specified in one or more processes in the flowchart and/or one or more blocks in the block diagram is implemented by executing the instructions by the processor of the computer or other programmable data processing devices.

These computer program instructions can also be stored in a computer-readable memory that can direct a computer or other programmable data processing devices to operate in a particular manner, such that the instructions stored in the computer-readable memory produce a product comprising an instruction device, the instruction device implementing functions specified in one or more processes of the flowchart and/or one or more blocks of the block diagram.

These computer program instructions may also be loaded onto a computer or other programmable data processing devices, so that a series of operation steps are executed on the computer or other programmable data processing devices to generate processing implemented by the computer, so that the instructions executed on the computer or other programmable data processing devices provide steps for implementing functions specified in one or more processes in the flowchart and/or one or more blocks in the block diagram.

In a typical configuration, a computing device comprises one or more processors (CPUs), an input/output interface, a network interface, and a memory.

The memory may comprise forms such as a non-permanent memory, a random access memory (RAM), and/or a non-transitory memory such as a read-only memory (ROM) or a flash RAM, in a computer-readable medium. A memory is an example of a computer-readable medium.

The computer-readable medium, comprising both permanent and non-permanent, and removable and non-removable medium, may achieve information storage by any method or technology. The information may be computer-readable instructions, data structures, modules of a program, or other data. Examples of the computer storage medium comprise but are not limited to, phase change memory (PRAM), static random-access memory (SRAM), dynamic random-access memory (DRAM), other types of random-access memories (RAM), read-only memory (ROM), electrically erasable programmable read-only memory (EEPROM), flash memory or other memory technology, compact disc read-only memory (CD-ROM), digital versatile disc (DVD) or other optical storage, magnetic cassettes, magnetic tape magnetic disk storage or other magnetic storage devices, or any other non-transmission media, which may be used to store information that may be accessed by the computing device. As defined herein, the computer-readable media do not comprise transitory computer-readable media, such as modulated data signals and carriers.

It should also be noted that the terms “include”, “includes”, or any other variations thereof are intended to cover a non-exclusive inclusion, so that a process, a method, a commodity, or a device that comprises a series of elements not only comprises those elements, but also comprises other elements that are not explicitly listed, or further comprises inherent elements of the process, the method, the commodity, or the device. Without further limitation, an element defined by a sentence “include a . . . ” does not exclude other same elements existing in a process, a method, a commodity, or a device that comprises the element.

The described content merely relates to preferable embodiments of the present application and is not intended to limit the present application. For a person skilled in the art, the present application may have various modifications and variations. Any modifications, equivalent replacements, improvements, etc. made within the spirit and principle of the present application shall all belong to the scope of protection of the present application.

### INDUSTRIAL APPLICABILITY

The technical solutions provided in the embodiments of the present application can be applied to the field of three-dimensional reconstruction. The embodiments of the present application use the method of acquiring a first image and a second image, wherein the first image and the second image are obtained by respectively collecting a target image by a pre-calibrated binocular camera, the target image is formed by a projected pattern projected onto a surface of an object to be measured, and the projected pattern is at least composed of binarized stripes containing feature points; respectively determining positions of feature points in the first image and the second image, and respectively determining a plurality of first adjacent domains corresponding to the feature points in the first image and a plurality of second adjacent domains corresponding to the feature points in the second image, wherein the feature points in the first image are in one-to-one correspondence with the first adjacent domains, and the feature points in the second image are in one-to-one correspondence with the second adjacent domains; matching the feature points in the first image with the feature points in the second image one to one according to matching degree between the first adjacent domains and the second adjacent domains; and performing three-dimensional reconstruction of the object to be measured according to matched feature points in the first image and the second image. By means of the method of using a projected pattern composed of randomly distributed binarized stripes at least containing feature points to scan the object to be measured, the purpose of completing the encoding and decoding of the object to be measured using fewer sequence images is achieved, thereby realizing the technical effect of shortening the time required for encoding and decoding the object to be measured, and thus solving the technical problem in the related art of low scanning efficiency for images such as teeth.

1. A method for three-dimensional reconstruction, comprising:
acquiring a first image and a second image, wherein the first image and the second image are obtained by collecting a target image, the target image is formed by a projected pattern projected onto a surface of an object to be measured, and the projected pattern comprises at least binarized stripes containing feature points;
respectively determining positions of feature points in the first image and the second image, and respectively determining a plurality of first adjacent domains corresponding to the feature points in the first image and a plurality of second adjacent domains corresponding to the feature points in the second image, wherein the feature points in the first image are in one-to-one correspondence with the first adjacent domains, and the feature points in the second image are in one-to-one correspondence with the second adjacent domains;
matching the feature points in the first image with the feature points in the second image one to one according to matching degree between the first adjacent domains and the second adjacent domains; and
performing three-dimensional reconstruction of the object to be measured according to matched feature points in the first image and the second image.

2. The method of claim 1, wherein the first image and the second image are obtained by respectively collecting the target image using a pre-calibrated binocular camera or a pre-calibrated monocular camera.

3. The method of claim 1, wherein the projected pattern is determined by the following manners:
determining types of the binarized stripes, wherein the types of the binarized stripes at least comprise one of the following: line segment stripes with endpoints as feature points and binarized stripes with feature points randomly distributed on stripes; and
arranging the binarized stripes according to predetermined distribution rules to form the projected pattern, wherein the line segment stripes are random in length, and the feature points at least comprise one of the following shapes: a horizontal line of a preset length, a spherical shape, a cross shape and a square shape.

4. The method of claim 3, wherein arranging the binarized stripes according to the predetermined distribution rules to form the projected pattern comprises:
determining a first distribution rule for the binarized stripes from a plurality of horizontal distribution rules included in the predetermined distribution rules, wherein the plurality of horizontal distribution rules comprises at least one of the following: horizontal spacings between laterally adjacent binarized stripes being equal, the horizontal spacings between the laterally adjacent binarized stripes being successively increased at equal intervals, and the horizontal spacings between the laterally adjacent binarized stripes being randomly selected from a preset distance interval;
determining a second distribution rule for the binarized stripes from the predetermined distribution rules according to the types of the binarized stripes; and
arranging the binarized stripes according to the first distribution rule and the second distribution rule to form the projected pattern.

5. The method of claim 4, wherein determining the second distribution rule for the binarized stripes from the predetermined distribution rules according to the types of the binarized stripes comprises:
in cases where the binarized stripes in the projected pattern are line segment stripes, selecting a second distribution rule from a plurality of vertical distribution rules included in the predetermined distribution rules, wherein the plurality of vertical distribution rules comprises at least one of the following: vertical spacings between longitudinally adjacent line segment stripes being equal, the vertical spacings between the longitudinally adjacent line segment stripes being successively increased at equal intervals, and the vertical spacings between the longitudinally adjacent line segment stripes being randomly selected from a preset distance interval; and
in cases where the binarized stripes in the projected pattern are binarized stripes in which feature points are randomly distributed on stripes, selecting a second distribution rule from a plurality of feature point distribution rules included in the predetermined distribution rules, wherein the plurality of feature point distribution rules at least comprises: spacings between a plurality of feature points being equal, and the plurality of feature points being randomly distributed on stripes.

6. The method of claim 1, wherein determining the plurality of first adjacent domains corresponding to the feature points in the first image comprises:
determining, from the first image, feature points to be matched;
determining a sub-image window of a preset size from the first image by using the feature points to be matched as a center; and
determining regions delimited by the sub-image window as the first adjacent domains.

7. The method of claim 6, wherein feature points matching the feature points to be matched are determined from the second image in the following manners, comprising:
determining first adjacent domains corresponding to the feature points to be matched in the first image;
sequentially determining a second adjacent domain corresponding to each feature point in the second image; and
determining matching degrees between the feature points to be matched and each feature point in the second image according to grayscale values of the feature points to be matched, a grayscale value of each feature point in the second image, an average grayscale value of the first adjacent domains corresponding to the feature points to be matched, and an average grayscale value of the second adjacent domain corresponding to each feature point in the second image; and selecting, from the second image, a feature point having the highest matching degree and meeting an epipolar constraint condition, and taking same as feature points matching the feature points to be matched in the second image.

8. The method of claim 2, wherein intrinsic and extrinsic parameters of the binocular camera are determined by the following manner, comprising:
extracting feature point coordinates from an image in a calibration board collected by the binocular camera; and
calculating the intrinsic and extrinsic parameters of the binocular camera according to the feature point coordinates of the image in the calibration board.

9. The method of claim 8, wherein calculating the intrinsic and extrinsic parameters of the binocular camera according to the feature point coordinates of the image in the calibration board comprises:
determining, among a plurality of intrinsic and extrinsic parameters of the binocular camera, target parameters needing to be calibrated, wherein the target parameters comprise a rotation angle and a translation displacement for transforming a plurality of feature points of the image in the calibration board from a world coordinate system to a camera coordinate system, a camera focal length and a radial distortion coefficient;
substituting three-dimensional coordinates of the plurality of feature points of the image in the calibration board and corresponding image coordinates into a preset system of linear equations to determine an optimal solution of the preset system of linear equations; and
determining the target parameters on the basis of the optimal solution.

10. The method of claim 9, wherein determining the target parameters on the basis of the optimal solution comprises:
determining, on the basis of the optimal solution, an x-axis component and a y-axis component in a rotation matrix corresponding to the rotation angle and an x-axis component and a y-axis component in a translation matrix corresponding to the translation displacement; and
sequentially determining the camera focal length and the radial distortion coefficient on the basis of the x-axis component and the y-axis component in the rotation matrix and the x-axis component and the y-axis component in the translation matrix.

11. The method of claim 2, wherein acquiring the first image and the second image comprises:
acquiring the target image at different moments respectively by means of the monocular camera, to obtain the first image and the second image; or
acquiring the target image by means of the monocular camera to obtain the first image, and modulating the first image to obtain the second image.

12. The method of claim 1, wherein the object to be measured comprises a tooth to be measured.

13. The method of claim 1, wherein the projected pattern is determined by the following manners:
combining vertical stripe segments of a first preset length in a vertical direction and horizontal stripe segments of a second preset length in a horizontal direction to form grid-like line segment stripes; and determining the projected pattern according to the grid-like line segment stripes; or
adjusting oblique angles of the line segment stripes, and determining the projected pattern by a plurality of line segment stripes inclined at a preset angle.

14. A projection optical system, comprising:
a light emission portion, configured to emit projection light,
a light transmission portion, disposed on a light exit side of the light emission portion such that the projection light emitted from the light emission portion forms a projected pattern after passing through the light transmission portion, the projected pattern comprises at least binarized stripes containing feature points.

15. The projection optical system of claim 14, wherein the light transmission portion comprises a plurality of micromirrors, and a plurality of micromirrors are controlled to rotate so that the projection light emitted by the light transmission portion forms the projected pattern after passing through the light transmission portion.

16. The projection optical system of claim 14, wherein the light transmission portion comprises a photomask, and at least one shielding object is arranged on the photomask for shielding the projection light, and the photomask is used for shielding a light path of the projection light so that the light path of the projection light traverses from a coverage area of the photomask, so that the projection light emitted by the light transmission portion forms the projected pattern after passing through the light transmission portion.

17. The projection optical system of claim 14,
wherein types of the binarized stripes at least comprise one of the following: line segment stripes with endpoints as feature points and binarized stripes with feature points randomly distributed on stripes; wherein the line segment stripes are random in length, and the feature points at least comprise one of the following shapes: a horizontal line of a preset length, a spherical shape, a cross shape and a square shape.

18. The projection optical system of claim 17,
wherein a plurality of horizontal distribution rules of the binarized stripes comprise at least one of the following: horizontal spacings between laterally adjacent binarized stripes being equal, the horizontal spacings between the laterally adjacent binarized stripes being successively increased at equal intervals, and the horizontal spacings between the laterally adjacent binarized stripes being randomly selected from a preset distance interval.

19. The projection optical system of claim 18,
wherein a plurality of vertical distribution rules of the binarized stripes comprise at least one of the following: vertical spacings between longitudinally adjacent line segment stripes being equal, the vertical spacings between the longitudinally adjacent line segment stripes being successively increased at equal intervals, and the vertical spacings between the longitudinally adjacent line segment stripes being randomly selected from a preset distance interval.

20. A system for scanning oral cavity, comprising:
a projection optical system, comprising a light emission portion and a light transmission portion, wherein the light emission portion is configured to emit projection light, the light transmission portion is disposed on a light exit side of the light emission portion such that the projection light emitted from the light emission portion forms a projected pattern after passing through the light transmission portion, the projected pattern comprises at least binarized stripes containing feature points;
an image acquisition optical system, comprising one or more cameras for acquiring a projected pattern projected onto a surface of an object to be measured;
a software algorithm system, configured to perform the method for three-dimensional reconstruction as claimed in claim 1.
